(19) United States
(12) Patent Application Publication
(10) Pub. No.: US 2007/0001794 A1
(43) Pub. Date: Jan. 4, 2007

(54) Dsl modem and transformer

(76) Inventors: Neil McNeill Alford, London (GB); Ener Orlando Salinas Flores, London (GB); Stavros Dimitriou, London (GB)

Correspondence Address: Anthony R Barkume, 20 Gateway Lane, Manorville, NY, 11949, US

(21) Appl. No.: 10/572,407

(22) PCT Filed: Sep. 16, 2004
(86) PCT No.: PCT/GB04/50011

§ 371 Date: Sep. 5, 2006

(30) Foreign Application Priority Data
Sep. 16, 2003 (GB) 021658.7

(51) Int. Cl. H01F 5/00

(52) U.S. Cl. 336/200

(57) ABSTRACT

A digital subscriber line (DSL) modem (12, 14) comprising a line interface transformer (22) having a primary circuit for coupling to a transmission line and a secondary circuit for outputting a signal transmitted over said transmission line, each circuit being formed of a continuous electrically conductive material and in which the primary circuit and the secondary circuit are substantially parallel and are in substantially the same plane.

### FIELD OF THE INVENTION

The present invention relates to a Digital Subscriber Line (DSL) modem, a transformer for use in such a modem, a method of transmitting electronic data, a method of manufacturing a DSL modem and to a coreless transformer.

### BACKGROUND OF THE INVENTION

Michael Faraday invented the transformer in 1831. It is noted that the original designs of the transformer were intended mainly for power applications. The design is bulky and cumbersome as it involves a nucleus of ferrite surrounded by many turns of copper. This design has been kept with very little variation for more than a century in spite of a manifold of uses ranging from high voltage to sophisticated micro-electronic equipment.

In recent times complex DSP techniques and coding have been developed to utilise the telephone lines of the existing telephone network, or Plain Old Telephone System (POTS), for transmission of electronic data at high data rates (of the order of megabits per second). A conventional telephone transmission line typically comprises a pair of copper conductors that connect a telephone set to the nearest Central Office (CO or telephone network operator), digital loop carrier equipment, remote switching unit or any other equipment serving as the extension of the services provided by the CO. This pair of copper conductors is frequently referred to as a “twisted pair”. A number of such twisted pairs are generally bundled together within the same cable binder group.

Transmission of electronic data by this means is generally referred to as Digital Subscriber Line or “DSL”. A DSL is established between two modems coupled by a twisted copper pair, one modem located at the user (Customer Premises Equipment—CPE) and the other located at the CO. A family of different standards have been developed under DSL, generally referred to as “xDSL”, and new standards are under development. Variations of DSL technology in the family include SHDSL (symmetric high-bit-rate DSL), HDSL2 (second-generation high bit-rate DSL), RADSL (rate adaptive DSL), VDSL (very high-bit-rate DSL), and ADSL (asymmetric DSL). The frequencies used for transmission of electronic data using DSL technology ranges from about 25 kHz up to several MHz.

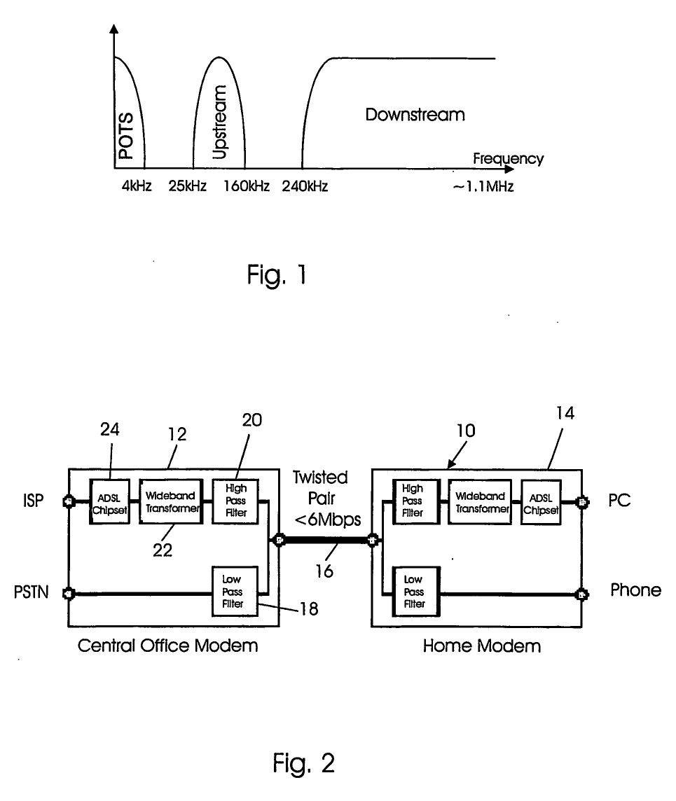

Some DSL technologies, such as ADSL, have the advantage that ordinary voice data transmissions i.e. POTS can share the same twisted pair with electronic data transmissions. FIG. 1 shows how the frequency spectrum is divided for ADSL. A lower frequency band (0-4 kHz) is used for voice data, while an upper frequency band (25 kHz-1.1 MHz) is used for electronic data. The upper frequency band is further split into two bands, one for upstream transmission (i.e. user to CO) and the other for downstream transmission (i.e. CO to user). The downstream transmission band is much larger than the upstream transmission band as most users will download far more data from the Internet than they will upload. 256 frequency carriers placed at 4.3125 kHz intervals provide a bandwidth of approximately 1.1 MHz for the upstream and downstream transmission bands. The actual downstream data rate achieved by ADSL is dependent on a large number of factors including length of the twisted pair, its wire gauge, presence of bridged taps and cross-coupled interference.

The modems at each end of the twisted pair employ filters to filter either the data transmission band or the voice band for subsequent processing.

For many years in POTS a line interface transformer has been used as an interface between the telephone line and the electric circuits in the users home or office. This interface provides safety for the user by isolating the twisted pair from the user to prevent large voltages induced in the twisted pair (e.g. lightning strike) from being transmitted to the circuits in the user's home.

With the advent of DSL technology, several additional requirements have been placed on such line interface transformers including: provision of a flat frequency response over a much wider bandwidth; excellent signal transmission properties (ideally 1:1), impedance matching and minimal insertion loss. The ability of the transformer to faithfully reproduce the input signal is of particular importance in view of the sensitive nature of the DSL signal.

Up to the present day transformers for use in DSL modems have been of the traditional type in which an iron core is used to couple the magnetic flux from the copper primary winding to the copper secondary winding. This is because, at DSL frequencies and particularly the low frequencies, the skin depth in which 1/e or 63% of the primary winding magnetic field is absorbed by the secondary winding ranges from 0.667 mm at 10 kHz to 0.067 mm at 1 MHz. The remainder of the available energy is not absorbed and passes through a conductor of these respective thicknesses. Thus in order to obtain a good flux linkage or coefficient of coupling between the primary and secondary windings it is necessary to (1) have enough material present in the secondary winding to absorb the energy from the primary winding and (2) to ensure that the magnetic flux from the primary winding cuts that material as it expands and collapses. This is particularly important in DSL transformers where there is usually a 1:1 winding ratio. Any flux leakage is highly undesirable, as the signal will not be reproduced without distortion

As mentioned above, the traditional and well-accepted solution to this problem in the field of transformers for use in DSL modems is to use an iron core transformer. Such ADSL transformers have line-side inductances ranging from a few hundreds of microhenries to a few millihenries. They do not need to carry DC; however they are gapped to control their inductance within a ±5% to ±10% range. Leakage inductances are roughly proportional to line-side inductances, ranging from a few microhenries to a few tens of microhenries. Echo cancellation is employed in ADSL systems in the frequency range where the upstream and downstream signals overlap, making distortion a critical factor. Typical distortion requirements are −85 dB maximum THD for the CPE end and −80 dB THD for the CO end; both measured with a 15 Vp-p signal at 100 KHz.

DSL is becoming the most popular option for both businesses and consumers for high-speed communications and Internet access. The major success of DSL technology worldwide places all telecom manufacturers under pressure for next-generation DSL products. In order to maintain and improve DSL prevalent availability, service quality and performance, the main priority is to design analogue circuitry with high signal reliability and low power operation. Therefore, analogue design community faces new challenges of requirements for analogue front-end building blocks including a crucial component, the line interface transformer. All these parameters affect dramatically to the overall performance of the transmission and the quality of service.

However typical ADSL transformers measure about 1 cm by 1 cm by 1 cm i.e. an overall aspect ratio of the device of approximately 1:1 (a three-dimensional object with a shape resembling that of a cube). Unfortunately this arrangement is bulky and expensive to manufacture needing a large amount of raw material and skilled labour to assemble the parts. The continuing pressure for smaller electronic devices is pressing manufacturers to find a smaller and lighter replacement for the traditional transformer as used in DSL modems that does not rely on a ferrite core, but which does not result in lower performance.

### SUMMARY OF THE INVENTION

Preferred embodiments of the present invention are based on the insight that it is possible to replace the ferrite core in a line interface transformer designed to operate at DSL frequencies with a geometrical winding structure substantially without degradation in performance. A particular advantage is that the geometrical structure is smaller (in one dimension at least) and lighter than the equivalent conventional DSL ferrite core transformer.

According to the invention there is provided a transformer which comprises a primary circuit and a secondary circuit each circuit being formed of a continuous electrically conductive material and in which the primary circuit and the secondary circuit are substantially parallel and substantially in the same plane.

In such an arrangement the circuits can sometimes be referred to as internested or interwoven.

Electrical conductor can be any electrically conductive material such as metal, conductive plastic etc. and typically is in the form of a wire, conducting track on a printed circuit board, tape etc.

In such a transformer there is no ferromagnetic (usually ferrite) element and the transformer has a large aspect ratio. The primary and secondary circuits achieve the transformer action mainly via a remarkably good local magnetic flux linkage between neighbouring conductors rather than global magnetic flux transference through a low-reluctance ferromagnetic path as in the case of standard transformers.

The transformer preferably comprises a primary circuit and a secondary circuit and each circuit is formed of a continuous electrically conductive material in the form of a spiral wire and the wires forming the primary and secondary circuits are side by side to form two internested separate spirals. The spiral can be circular, elliptical, square, rectangular, oval or non-regular.

A convenient design to the circuits is an Archimedean spiral with polar equation r(θ)=αθ, where θ is the angle in polar coordinates, r is the radius and α is a constant that regulates the number of turns and the spacing. As the angle increases, so does the radius. Preferably the number of turns in the spiral (of any shape) is at least 10 with between about 20 and 40 turns of each circuit being preferable.

The invention also provides a quasi planar transformer which comprises a plurality of layers with each layer comprise a transformer as described above and in which the primary circuits of each layer are connected together and the secondary circuits of each layer are connected together; in one embodiment the layers are substantially parallel i.e. the structure comprises a plurality of planar transformers stacked one above each other. Alternatively the transformers can be side by side and are preferably in the same plane. It has been found that stacking the transformers in this fashion offers particular improvement in signal transfer over the DSL frequency range. “Quasi planar” may mean that the transformer is three-dimensional but that one of the dimensions is relatively small compared to the others. This is particularly useful as circuits are becoming smaller and therefore PCB space is at a premium. In one embodiment such a quasi-planar transformer has a width and a depth that are between 5 and 20 times the height of the transformer respectively.

A way to achieve this linkage is through a compact spiral arrangement, namely, if the primary and secondary circuits of each transformer are in the same plane. This leads to two parallel spirals (hence its name “bifilar” transformer). Connections in series of the bifilar coils improve the signal transmission. The arrangement increases the height of the device. However the total aspect ratio, defined as the ratio of the diameter: height of the device, is kept relatively large and, for this reason, it represents a quasi-planar transformer (QPT). The layers can be connected in series and/or parallel.

It is a feature of the invention that it provides a substantially two-dimensional solution for performing the DSL transformer function which comprises of a planar structure with two coils in bifilar design characterised by the absence of a ferromagnetic element.

In a typical transformer there can be at least 10 layers each of which is in the form of a planar transformer.

Features of the invention are that there is an absence of a ferromagnetic element and it produces a very large aspect ratio transformer device e.g. an aspect ratio of 1:5 or more and preferably with an aspect ratio more than 1:10 or more than 1:20. It has the additional advantage in that the manufacturing process is amenable to planar film techniques and also to multilayered fabrication techniques. The substance of the invention is that a three-dimensional ferrite-core based design has been replaced by a substantially two-dimensional multilayered design in which all planar layers are connected to each other in series. This invention is particularly useful in, but not restricted to, Asymmetric Digital Subscriber Line (ADSL), ADSL2+ and Very High Data-rate DSL (VDSL) applications. Surprisingly, it is found that removal of the ferromagnetic element and a large physical aspect ratio in the device is possible and transforming action is observed. In addition the avoidance of a ferromagnetic element (such as ferrite) eases the construction operation and cost.

A comparison with conventional transformers is shown below:—

| | Technology | |
|---|---|---|
| | Conventional Wire Wound | Novel Circular Spiral |
| | Transformer | Transformer |
| Description | Magnetic Interface | Air-core |
| Design | 3 dimensional | 2 dimensional |

In order for the multilayered bifilar transformer to be connected, many spiral layers are connected in series; this is exemplified below.

According to the present invention there is provided a digital subscriber line (DSL) modem comprising a line interface transformer having a primary circuit for coupling to a transmission line and a secondary circuit for outputting a signal transmitted over said transmission line, each circuit being formed of a continuous electrically conductive material and in which the primary circuit and the secondary circuit are substantially parallel and are in substantially the same plane. As used herein “plane” is term of convenience to aid understanding and is intended to mean that circuits lie in the same plane, although it will be appreciated that they do not lie only within that plane. A DSL modem may be any suitable modem designed to be connected to a telephone socket or other transmission line socket through which data may be sent and received. For example, the DSL modem may be sold as a card for insertion into a personal computer or as an adapter for use with a landline telephone and personal computer. Transmission line may mean twisted copper pair or and ISDN line for example. Electrically conductive material may mean any material suitable for carrying a DSL signal. Preferably the ratio of the number of turns of the primary circuit to the number of turns of the secondary circuit is 1:1.

Preferably said primary circuit and said secondary circuit are in the form substantially parallel spirals of the conductive material in substantially the same plane. The spiral may be substantially circular, elliptical, square, rectangular, oval or non-regular.

Advantageously, the spiral conforms substantially to a spiral formed by the polar equation r(θ)=αθ, where θ is the angle in polar coordinates, r is the radius and a is a constant that regulates the number of turns and the spacing.

Preferably, the number of turns of each circuit is at least 10. Good results have been obtained with such an arrangement.

Advantageously, there is a plurality of planes, each plane forming a layer and in which said primary circuit of each layer is connected together and said secondary circuit of each layer is connected together.

Preferably, said layers are substantially parallel.

Advantageously, the separation between said layers is not more than 0.5 mm. This helps to ensure good transformer action over the frequency band of interest.

Preferably, the primary circuits are connected in parallel or in series with one another, and the secondary circuits are connected in parallel or series with one another. A series connection between respective circuits in each layer is preferred as this helps to increase the inductance.

Advantageously, there are at least 10 layers. This has been found to produce good results for the purposes of signal transmission over the transformer.

Preferably, the transformer has an aspect ratio defined as diameter to width of 1:5 or more. Thus the height of the transformer is greatly reduced compared to existing DSL transformers.

Advantageously, said line interface transformer does not comprise ferromagnetic core. Enabling removal of this component greatly reduces weight, size and cost of the line interface transformer and thereby of the DSL modem.

According to another aspect of the present invention there is provided for use in a DSL modem, a line interface transformer having any of the line interface transformer features of any preceding claim.

According to another aspect of the present invention there is provided a method of transmitting electronic data over a transmission line, which method comprises the steps of placing said electronic data on said transmission line via a line interface transformer as claimed in any preceding claim. This method might be performed by a telephone company who transmit data (e.g. web pages, e-mail, files) to users utilising a DSL connection. The data may be digital data and the method may further comprise the step of transmitting this data via the line interface transformer in a modulated form such as by DMT and/or QAM. The method may further comprise the step of transmitting the data via the line interface transformer over a number of carrier frequencies. In one embodiment the carrier frequencies are spaced apart over a bandwidth, which may be approximately 1 MHz, from about 26 kHz to 1.1 Mhz. Preferably the digital data is transmitted via the transformer using an xDSL signal.

According to another aspect of the present invention there is provided a method of manufacturing DSL modem, which method comprises the step of a inserting a line interface transformer as set out above and electrically connecting said transformer thereto.

According to yet another aspect of the present invention there is provided a coreless transformer for passing a low frequency band data signal between about 10 kHz and 2 MHz, which transformer comprises a primary circuit and a secondary circuit having a number of turns such that said transformer comprises a plurality of layers, each layer having alternating primary and secondary conductors adjacent one another, there being a combination of said number of turns and a number layers sufficient to obtain a transformer action for passing said data signal from said primary circuit to said secondary circuit.

Advantageously, said layer extends radially outwardly from a centre of said transformer. Thus the layer may be considered to define a plane, although it will be appreciated of course that the primary and secondary circuits are three-dimensional and will contain the plane but not lie exclusively within it.

Preferably, said layer forms an annulus around an axis of said transformer. In one embodiment the winding is such that the primary and secondary circuit form a three dimensional structure such that magnetic flux around the primary circuit cuts the secondary circuit on either side and above and below each portion of the primary circuit. This geometrical structure provides transformer action that is useful for signal transfer applications where it is important to pass a signal substantially without distortion, amplitude loss, phase shifts, etc. but which does not require the presence of a ferrite core. Furthermore the structure can be smaller than existing transformers for signal transfer applications.

Advantageously, separation between said primary and secondary conductors is between about 0.02 mm and 0.075 mm to obtain local flux linkage. “Local” may mean flux linkage between adjacent portions of the primary and secondary circuits.

Advantageously, the separation between said layers is between about 0.02 mm and 0.2 mm to obtain global flux linkage. “Global” may mean the overall energy transfer characteristics of the transformer i.e. the ability to faithfully transfer the input DSL signal.

Preferably, there are at least ten layers and about 20 turns of each circuit. This has been found to provide useful signal transfer properties in DSL frequency band, currents and voltages. It will be appreciated that the number of turns and number of layers may be varied by one skilled in the art whilst still achieving the transformer action necessary to pass a DSL signal. However, good signal filtering techniques in a DSL modem may permit the number of turn/number of layers to be reduced, providing the substantially linear transfer characteristics are maintained over the DSL frequency band of interest. Furthermore, different manufacturing techniques may result in different number of turns/layers required to achieve the same result. For example hand or machine winding techniques with insulated wires may permit there to be slightly fewer turns/layers since the wires are relatively close together compared to PCB manufacturing techniques. In PCB since the conductive tracks are not insulated, spacing between the tracks needs to be larger to inhibit the chances of a short circuit.

According to another aspect of the present invention there is provided an electrical circuit comprising a coreless transformer as set out above. The circuit may be a DSL modem circuit embodied in a stand-alone unit or PC card for example.

For a better understanding of the present invention reference will now be made by way of example only to the accompanying drawings in which:—

FIG. 1 is a schematic graph of frequency vs. amplitude showing the frequency bands used by POTS and ADSL;

FIG. 2 is a block diagram of two ADSL modems in accordance with the present invention connected by a twisted pair;

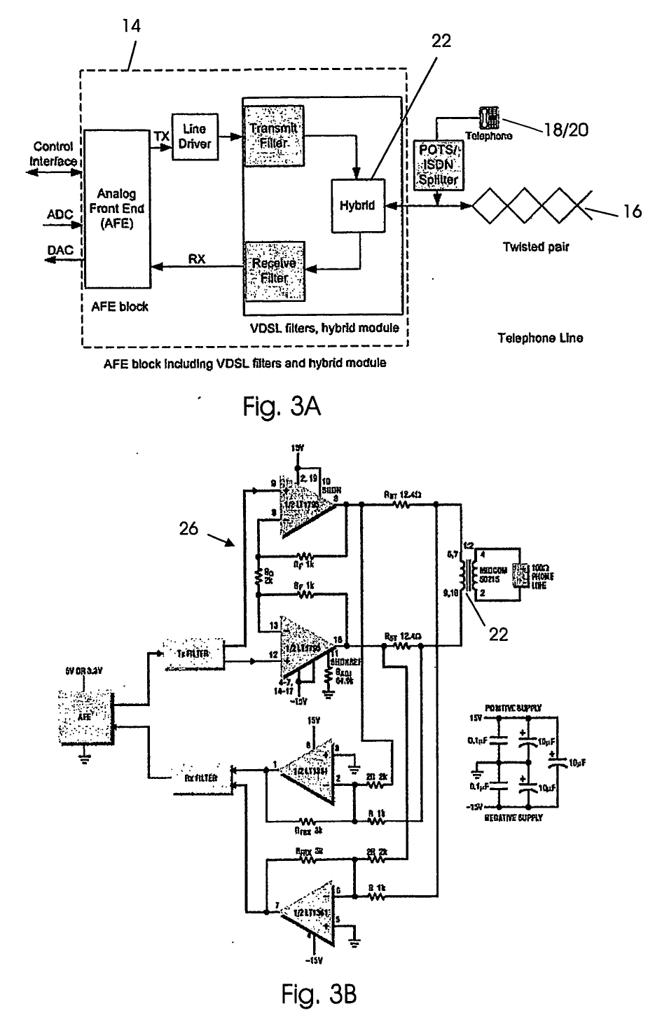

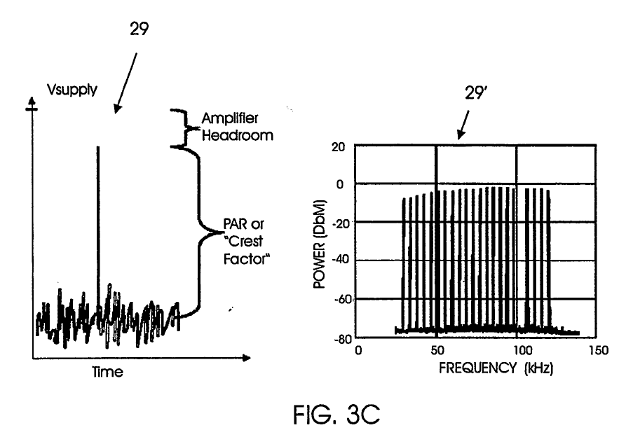

FIG. 3A shows further detail of one of the ADSL modems in FIG. 2;

FIG. 3B is a schematic circuit diagram of part of a DSL modem circuit showing the location of the line interface transformer;

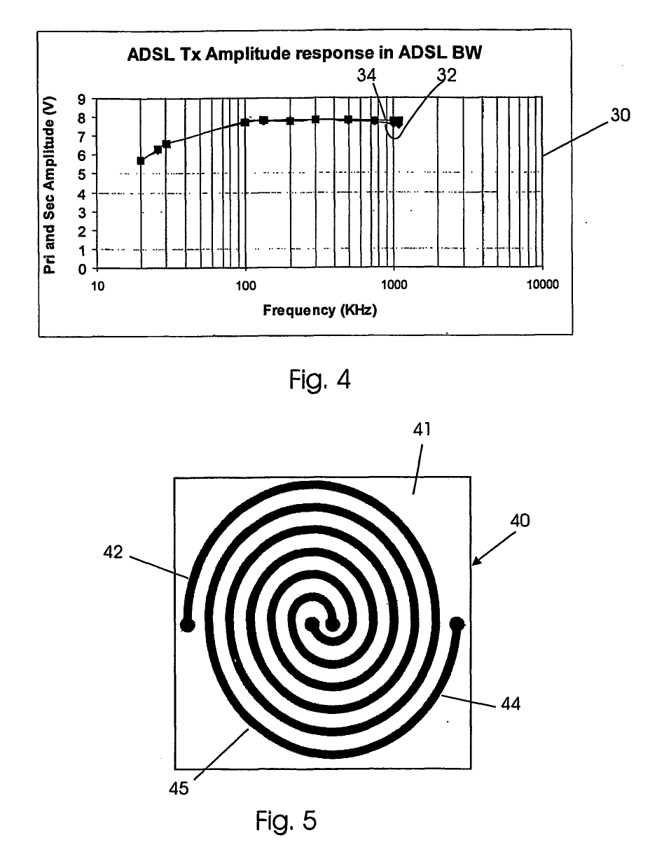

FIG. 4 is a graph of frequency vs. amplitude for a standard ADSL transformer;

FIG. 5 is a schematic plan view of a first embodiment of a transformer in accordance with the present invention;

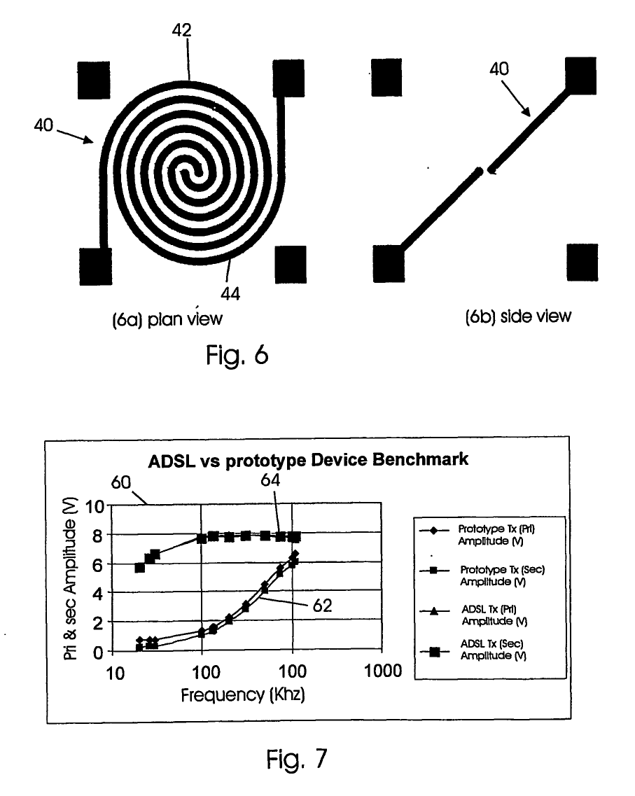

FIG. 6a is a schematic plan view of the transformer of FIG. 1 connected to power terminals;

FIG. 6b is a side view of the transformer of FIG. 2a;

FIG. 7 is a graph of frequency vs. amplitude for a standard ADSL transformer and the transformer of FIG. 5;

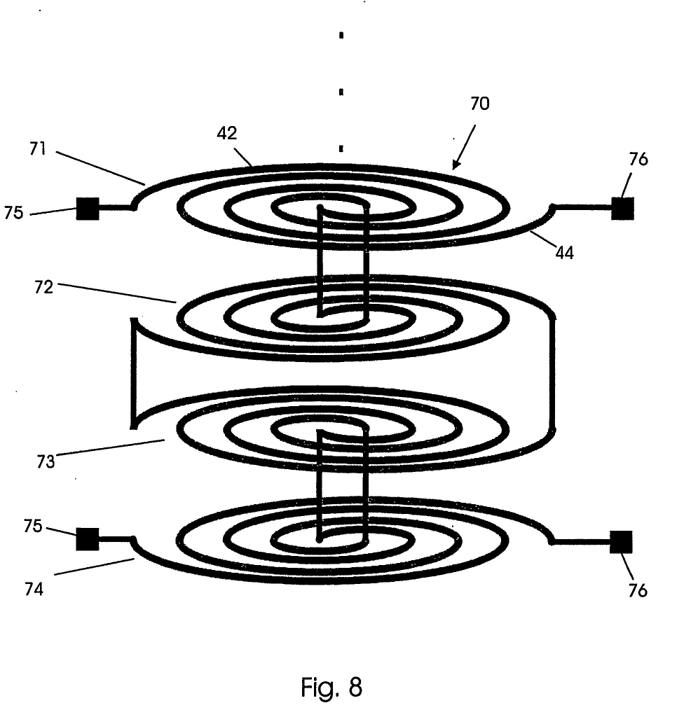

FIG. 8 is a schematic side view of a second embodiment of a transformer in accordance with the present invention;

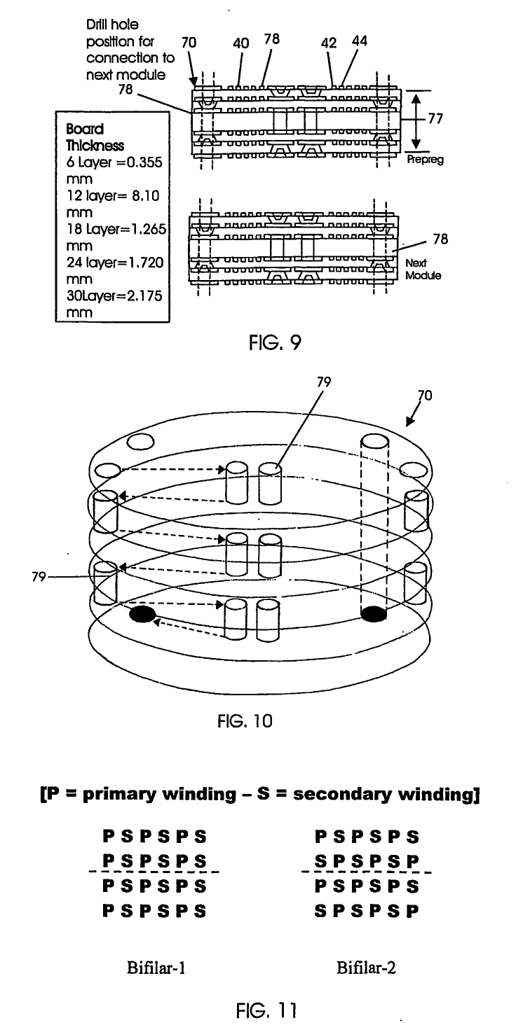

FIG. 9 is a schematic cross-section through two PCB modules each comprising a transformer similar to that in FIG. 8;

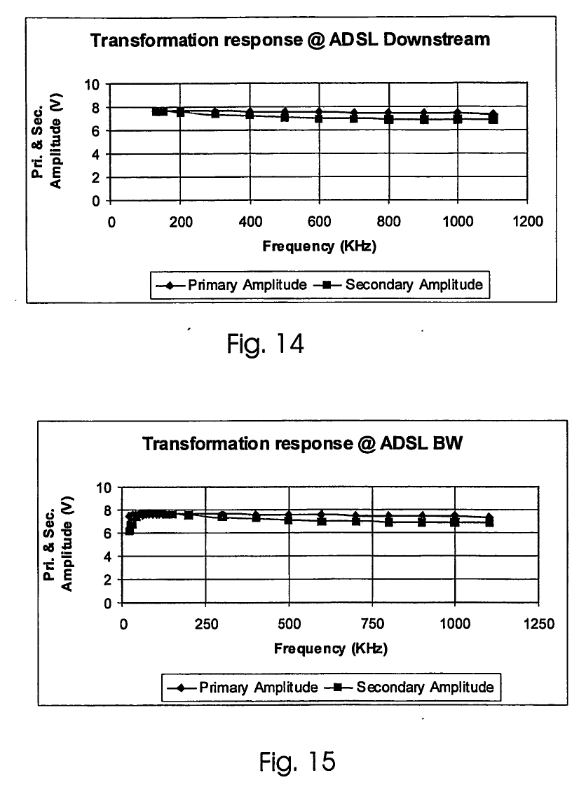

FIG. 10 is a schematic perspective view of the PCB modules of FIG. 14 showing the points of electrical connection between PCB layers;

FIG. 11 is a schematic cross section through two conductor structures according to the present invention;

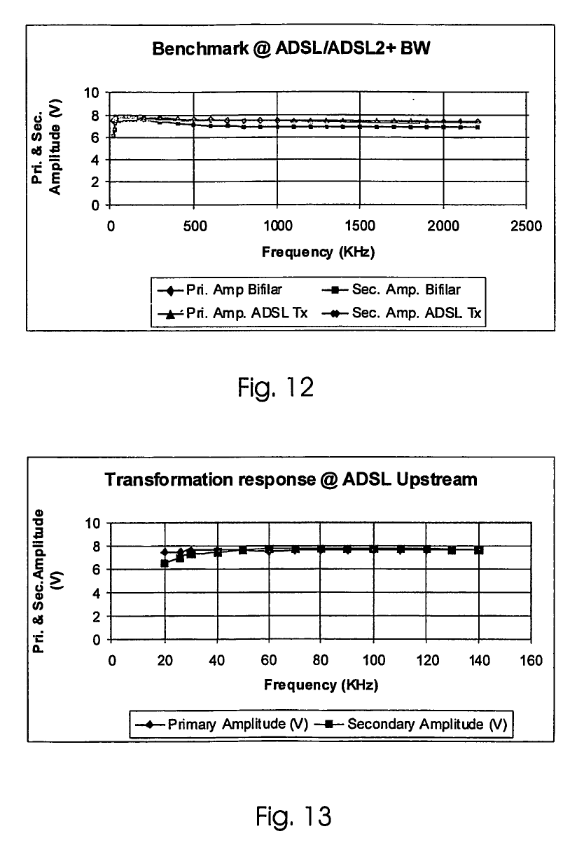

FIG. 12 is a graph of frequency vs. amplitude for the transformer of FIG. 9 up to the high frequency end of ADSL2+;

FIG. 13 is a graph of frequency vs. amplitude for a hand-wound transformer in the ADSL upstream bandwidth;

FIG. 14 is a graph of frequency vs. amplitude for the hand-wound transformer in the ADSL downstream bandwidth;

FIG. 15 is a graph of frequency vs. amplitude for the hand-wound transformer across the whole ADSL bandwidth;

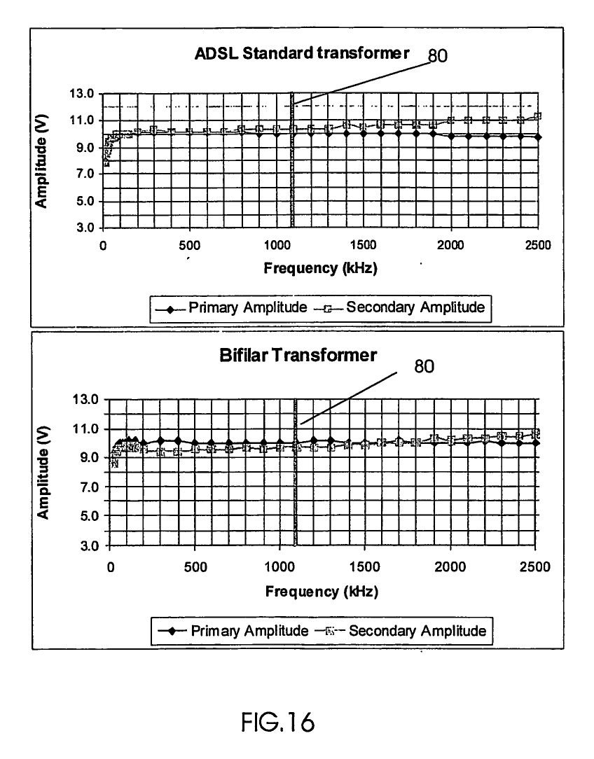

FIG. 16 shows two graphs of frequency vs. amplitude comparing a standard ADSL transformer and the hand-wound transformer; and

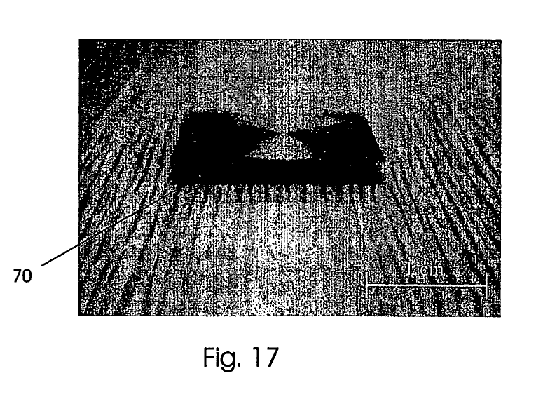

FIG. 17 is photograph of the PCB transformer of FIG. 9.

Referring to FIGS. 2 and 3A an ADSL generally identified by reference numeral 10 is established between two modems 12, 14 over a twisted pair 16 of copper wire. In functional terms the modems 12, 14 are identical and thus only one will be described in detail. The modem 12 comprises a low pass filter 18 for filtering the POTS voice frequency band (˜0-4 kHz) and a high pass filter 20 for filtering the ADSL frequency band (˜26 kHz-1.1 MHz). A wideband transformer 22 comprising a wire-wound three dimensional ferrite core lies downstream of the high pass filter 20 and serves to isolate the remaining downstream circuitry from the twisted pair 16 as described above. An ADSL chipset 24 receives the ADSL signal (i.e. frequencies above ˜26 kHz) from a secondary winding (not shown) of the wideband transformer 22. The ADSL chipset 24 serves to amplify and decode the ADSL signal for subsequent processing. The ADSL chipset 24 passes the processed ADSL signal either to an Internet Service Provider (ISP) or to a Personal Computer (PC), depending on the location of the modem. The low pass filter 18 passes the low frequency POTS signal either to a Public Switched Telephone Network (PSTN) or a telephone depending on whether the modem is at the CO or CP. FIG. 3B shows the location of the wideband transformer 22 in a typical ADSL circuit 26 that is part of both the modems 12, 14.

Referring to FIG. 3C the nature of the DSL signal is illustrated by two graphs 29 and 29′. ADSL relies on Discrete MultiTone (DMT) modulation to carry digital data over phone lines. The ADSL spectrum occupies frequencies from ˜26 kHz to 1.1 MHz while reserving the space below 20 kHz for voice signals (see FIG. 1). DMT signals viewed in the time domain appear as a pseudo-random noise signal and graph 29 suggests that DMT signals typically produce low rms voltage levels. However, xDSL line driver amplifiers (see FIG. 3C) must be capable of delivering peak voltages caused by the finite probability that many of the carriers in several sub-bands or tones may align in phase. Dynamic headroom allowances must be made in order to reproduce these large peaks when they occur.

DMT modulation appears in the frequency domain as power contained in several individual frequency sub-bands, sometimes referred to as tones or bins, each of which are uniformly spaced in frequency 4.3125 kHz apart (see graph 29′). A uniquely encoded Quadrature Amplitude Modulated (QAM)-like signal occurs at the centre frequency of each sub-band or tone. In the frequency domain depicted an upstream DMT signal produces peaks at each sub-band of approximately −1 dBm. Combining the power in each sub-band, a total power of 13 dBm is delivered to the load. Maintaining enough voltage headroom so that the amplifier can deliver undistorted peaks is challenging. The ratio of these infrequent peaks to the rms level in a DMT waveform is known as the peak to average ratio (PAR) or “crest factor”. A crest factor of 5.3 is typically used when designing the line driver hybrid for ADSL modems.

Difficulties will exist when decoding the information contained in DMT sub-bands if a QAM signal from one sub-band is corrupted by the QAM signal(s) from other sub-bands. Intermodulation distortion is the primary concern as typical xDSL downstream DMT signals may contain as many as 256 carriers (sub-bands or tones) of QAM signals. In xDSL modems DMT signal fidelity is required so that demodulators can accurately detect analogue signal amplitudes. ADCs can then accurately translate magnitude and sign information contained within each sub-band into corresponding digital bit streams. Bit errors occur when error-correction schemes cannot recover a piece of corrupted data that may have been caused by a lack of DMT signal fidelity. In short, DMT signal fidelity must be maintained through the ADSL line driver and bridge hybrid in order to preserve performance, minimise data corruption and improve data transfer rates in DSL modems.

Transformers find many applications where the current and voltage capabilities of active devices need to be matched to different load impedances. Since a transformer reflects the secondary load impedance back to the primary by the square of the turns ratio, the current drive demands increase while the voltage drive decreases.

ADSL modems require analogue bridge hybrid circuits to provide several important functions. The bridge hybrid transmits and receives data contained in analogue signals over the telephone lines, separates the receive signal from the transmitted signal, provides proper line termination impedance and isolates the line from the modem. It can also be designed to optimise power delivered to the line.

The functional requirements of the wideband transformer 22 within this context are set out in an ADSL standard. The requirements are given in the table below:—

TABLE
ADSL requirements

| | | Full Rate | Full Rate |
|---|---|---|---|
| | | ADSL | ADSL |
| Parameter | | Downstream | Upstream |
| Characteristics | Channels Used | 31 to 256 | 6 to 30 |
| | Frequency Band (KHz) | 133.7 to 1104 | 25.8 to 129.4 |
| | Bandwidth (KHz) | 970.3 | 103.5 |
| | Power Spectral Density, | −40 | −37 |
| | PSD (dBm/Hz^{1/2}) | | |
| | Line Power (dBm) | 20 | 13 |
| | RMS Line Power (mW) | 100 | 20 |
| | Line Impedance (Ω) | 100 | 100 |
| Electrical | RMS Line Voltage (V) | 3.1 | 1.4 |
| requirements | RMS line Current (mA) | 31 | 15 |
| | Peak-to-Average Ratio, | 5.3 | 5.3 |
| | PAR | | |
| | Peak Line Voltage (V) | 16.5 | 7.6 |
| | Peak-to-Peak Line | 33 | 15.2 |
| | Voltage (V) | | |
| | Peak Line Current (mA) | 170 | 76 |
| | Peak Line Power (mW) | 2725 | 580 |
| Theoretical | Bits/Symbol | 15 | 15 |
| date rates | Bits/Channel (Kbits/s) | 60 | 60 |
| | Max Data rate for | 13.5 Mb/s | 1.4 Mb/s |
| | Channel Used | | |

In particular, the wideband transformer 22 must pass the signal from the twisted pair 16 substantially without distortion, loss in amplitude, phase shifts and harmonics across the ADSL frequency band. In particular, the modem 14 sends signals representing electronic data to the telephone company modem 12 between 26 KHz and 138 KHz, and receives signals from 138 KHz up to 1.1 MHz. Referring to FIG. 4 a frequency response curve for the wideband transformer 22 (APC Limited model 41199 0040C) generally identified by reference numeral 30 comprises a response curve 32 for a primary winding of the transformer and a response curve 34 for a secondary winding of the transformer with a test signal of 7.5V throughout the ADSL bandwidth. The frequency response of the secondary winding is relatively flat between about 100 kHz and 1 MHz. However, between about 20 kHz and 100 kHz the output voltage from the secondary winding rolls off as frequency decreases. This is due to the flux linkage problem at low frequency mentioned in the introduction. In particular, as frequency decreases the skin depth increases i.e. assuming everything else remains constant, the amount of material in the winding needed to absorb 63% of the available energy contained in the magnetic flux increases. If a greater proportion of energy transfer is required at this lower frequency, the accepted solution in the art would be either to increase the amount material in the secondary winding and/or increase the size of the iron core to concentrate the magnetic flux. The applicant has found a way the remove the iron core of typical DSL transformers without a substantial loss in flux linkage.

Referring to FIGS. 5 and 6, a transformer generally identified by reference numeral 40 comprises two spiral circuits: a primary circuit 42 and a secondary circuit 44. It will be noted that there is no ferrite core. The two circuits are parallel to one another and are inter-wound with one another substantially in the same plane to form Archimedean spirals. Each circuit is etched on a laminate circuit board 41 and comprises copper track 45 of approximately 0.075 mm width and 0.05 mm height above the circuit board 41. Each circuit has 30 turns and is of approximately 18.44 mm diameter. The spacing between the tracks of the primary circuit 42 and secondary circuit 45 (as measured between closest edges) is 0.075 mm. The overall diameter of the coil is 20 mm. Whilst it is preferred that the tracks be as close together as possible for induction purposes, it has be found that this width provides a useful balance between obtaining transformer action and reducing the chance of a short-circuit from a piece of dust for example.

The aim of this geometric arrangement of the primary circuit 42 and secondary circuit 44 is to achieve the transformer action mainly via local magnetic flux linkage among neighbouring conductor tracks rather than global magnetic flux transference through a low-reluctance ferromagnetic path as in the case of standard transformers.

Referring to FIG. 7 a graph comparing the frequency response of the transformer 40 and the wideband transformer 22 is generally identified by reference numeral 60. The response of the transformer 40 is identified by reference numeral 62 and the response of the wideband transformer 22 is identified by reference numeral 64. It will be seen that across the ADSL frequency range the transformer 40 performs relatively poorly. This is because there is a high proportion of flux leakage from the primary circuit 42 leading to a low inductance value. This is compounded by the skin depth problem with lower frequencies as described above. As a result there is less voltage induced in the secondary circuit 44, particularly at lower frequencies, which is highly undesirable for DSL applications where a 1:1 signal transfer is desired The wideband transformer 22 performs as described above.

The applicant has managed to improve the inductance of the transformer 40 as described below, without resorting to a ferrite core.

Referring to FIG. 8 a second embodiment of a transformer generally identified by reference numeral 70 comprises a four layers 71, 72, 73, 74, each layer being similar to the transformer 40 i.e. comprising a primary and a secondary circuit having the dimensions mentioned above. Each layer 71, 72, 73, 74 is shown spaced apart for clarity. Each circuit of each layer is connected to the corresponding circuit of the layer beneath so that all of the primary circuits are connected in series and all of the secondary circuits are connected in series respectively between their respective terminals 75, 76.

Referring to FIG. 9 the transformer 70 is shown in PCB circuit form. Each PCB layer holds one transformer 40 having 30 turns in the primary circuit and 30 turns in the secondary circuit; it measures 20 mm by 20 mm and is 0.2 mm thick (before pressing) i.e. it has a high aspect ratio (diameter:height). In manufacture six PCB layers are stacked, heated and pressed to form a module 77. The transformer 70 comprises 5 modules and therefore 30 layers. Within each module 77 primary circuits 42 and secondary circuits 44 are connected to the corresponding circuit on the layer beneath either near the centre of the PCB or near the edge of the PCB via drill holes 78. Furthermore the connection 79 between each PCB layer alternates between a centre position and an edge position as shown in FIG. 10. The separation between each module 77 is 0.2 mm and is provided by PCB laminate to insulate the upper circuits of one module from the lower circuits of another. A photograph of the PCB transformer 70 is shown in FIG. 17 from which it is apparent that it is “quasi-planar”. The small size is immediately apparent, particularly in terms of height. The PCB transformer 70 in FIG. 17 weighs 1.9 g compared to 6.3 g for a typical ADSL transformer. Such a weight saving (approximately 70%) offers significant advantages to industry in terms of manufacturing and transportation costs.

The aim of this geometric arrangement of the primary circuit 42 and secondary circuit 44 is to achieve the transformer action mainly via local three dimensional magnetic flux linkage among neighbouring conductor tracks rather than global magnetic flux transference through a low-reluctance ferromagnetic path as in the case of standard transformers. In particular, referring to FIG. 11 two primary circuit and secondary circuit conductor patterns are illustrated as “Bifilar-1” and “Bifilar-2”. Each of these arrangements comprises a three dimensional structure having a layer of alternating primary and secondary circuits when viewed in cross section. In the case of Bifilar-1 this layer may be said to define a horizontal plane. In the case of Bifilar-2 this layer may be said to define an annulus. The particular advantage of the three dimensional winding structure is that inductance of the primary circuit is increased and the flux linkage to the secondary circuit is improved, even at the low frequencies of DSL. Furthermore the structure provides low Q factor whereby a good frequency response is present over the whole ADSL frequency range. A particular advantage of the Bifilar-2 structure is that each primary wire has a secondary wire to either side and above and below. The secondary wires are in such close proximity that a very good local magnetic flux linkage is obtained. Furthermore as viewed on a larger scale the structures help to reduce parasitic capacitance between primary wires and secondary wires. When wires are wound to form these structures, the separation between the wires is simply the width of insulation between the two conductors (typically ˜0.2 mm). When using PCB manufacturing techniques the spacing will be slightly greater (˜0.075 mm) as the conductive tracks are not enclosed by insulation. Precaution needs to be taken against short-circuit as since the isolation safety function of a line interface transformer is paramount.

Referring to FIG. 12 a graph of voltage versus frequency is shown for the PCB transformer 70. A voltage of 7.5V was applied to the primary circuit over a frequency range of 20 kHz to 2.25 MHz. The transformer 70 shows an excellent linear response over the full range and into the frequencies for future versions of DSL (e.g. ADSL2+) despite some loss in amplitude of the signal in the second circuit which is attributable to imperfect flux linkage between the circuits.

It is possible to wind both the transformer 40 and the transformer 70 by hand or with machinery to obtain wire structures shown in FIG. 10. The applicant wound a particular example of the transformer 70 by hand. This comprised a copper wire (Road Runner RRW-P-105) of 0.19 mm with 0.01 mm insulation wound as closely together as the insulation would allow (i.e. wire spacing of 0.02 mm) into a spiral with each circuit having 30 turns. Each layer was constructed individually to produce a transformer similar to the structure of transformer 40. SELLOTAPE (approximately 0.05 mm thick) was used to hold the transformer together. Ten layers were then stacked on top of one another and the ends of each primary circuit and secondary circuit connected together so that the transformers were connected in series as shown in FIG. 7. Thus the spacing between each layer was approximately (0.1 mm). The resulting 10 layer, 30 turn transformer was then tested

Referring to FIGS. 13 to 15 graphs of frequency versus voltage for the transformer show a remarkable improvement in performance over the single layer version. A voltage of 7.5V was applied to the primary circuit The secondary circuit shows substantially a 1:1 transformation of the applied voltage across the ADSL bandwidth. Furthermore the response of the secondary circuit is substantially flat over that bandwidth, thereby providing the required linear response. The three dimensional structure of the wires mentioned above provides flux linkage between primary and secondary circuits on a local scale i.e. less than about 0.1 mm that mitigates the need for a ferrite core. Furthermore stacking the transformers results in an unexpected increase in energy transfer, with only a small loss in signal amplitude in the secondary circuit. This three-dimensional structure takes advantage of the fact that the magnetic field intensity falls off quickly from each primary winding. Therefore by interwinding the primary and secondary circuits and stacking them on top of one another, the required transformer action is seen at frequencies where it was previously thought impossible to obtain the necessary signal transmission without a ferrite core.

Referring to FIG. 16 two graphs compare the performance of the aforementioned ADSL transformer with the hand-wound transformer described above. A voltage of 10V was applied to the primary circuit. The hand-wound transformer performs well over the ADSL bandwidth and even avoids the resonance that starts to appear across the secondary circuit of the ADSL transformer above 800 kHz. The upper limit of the ADSL frequency band is identified by reference numeral 80.

The electrical specifications of this transformer are as follows:—

Specifications (Electrical at 25° C. - Operating Temperature −40° C. to +80° C.)

| Parameter | Conditions | Min | Typ | Max | Units |
|---|---|---|---|---|---|
| Resistance (Primary DCR) | 1-2 | 3.18 | 3.2 | 3.22 | Ohms |
| Resistance (Secondary DCR) | 3-4 | 3.07 | 3.1 | 3.13 | Ohms |
| Primary Inductance | Measured at 10 KHz, 0.1 Volts | −5% | 150 | +5% | μH |
| Leakage Inductance: | Measured at 100 KHz, 0.1 Volts | — | — | 2.51 | μH |
| | with (3-4) shorted | | | | |
| Interwinding capacitance: | Measured at 10 KHz, 0.1 Volts | — | 700 | 775 | pF |
| Turns ratio: | (1-2:3-4) CPE (Line to chip) | 0.95 | 1.0 | 1.05 | — |
| Voltage isolation: | 50 Hz DC (1-2:3-4) | — | 6 | — | KVrms |
| | 1 sec pulses, pri. to sec. | | | | |
| Operating range: | Ambient temperature | −40 | — | +80 | ° C. |
| Total Harmonic Distortion (THD) | Measured at 10 KHz, 1.0 Volts | −5% | −58 | +5% | dB |
| Total Harmonic Distortion (THD) | Measured at 100 KHz, 1.0 Volts | −5% | −64 | +5% | dB |
| Insertion Loss: | @ 1 MHz, | — | −0.4298 | — | dB |
| | @ 65 KHz | — | −3.0305 | — | dB |
| | @ 9.7 MHz | — | −3.0033 | — | dB |
| Return Loss: | @ 1 MHz | — | −16.408 | — | dB |
| | @ 200 KHz | — | −12.0 | — | dB |
| | @ 2.7 MHz | — | −12.0 | — | dB |
| Weight: | | — | 1.9 | — | g |

It will be seen from the Table 1 that the inductance and leakage inductance of the primary circuit are both of the correct order of magnitude for use in DSL modems. Furthermore the insertion loss is low over the range of ADSL frequencies.

It will be appreciated that the transformers described herein are amenable to various manufacturing processes including etching, printed circuit board, thin-film deposition and automated machine winding.

Variations in the diameter and material of wires (or width of track), spacing between the wires, spacing between layers, number of turns of each circuit and number of layers all affect performance of transformers as described herein. However, provided with the principle of forming a transformer with a bifilar structure of conductors substantially in the same plane and then stacking the conductors to form a three-dimensional structure the skilled person is able to adjust the various parameters above to obtain the desired low frequency wideband signal transmission characteristics whilst reducing weight and space.

1-23. (canceled)

24. A coreless transformer for passing a low frequency band waveform between about 10 kHz and 2 MHz, which transformer comprises a primary circuit and a secondary circuit having a number of turns such that said transformer comprises a plurality of layers, each layer having alternating primary and secondary conductors adjacent one another, there being a combination of said number of turns and a number layers sufficient to obtain a transformer action for passing said waveform from said primary circuit to said secondary circuit.

25. A coreless transformer as claimed in claim 24, wherein said layer extends radially outwardly from a centre of said transformer.

26. A coreless transformer as claimed in claim 24, wherein said layer forms an annulus around an axis of said transformer.

27. A coreless transformer as claimed in claim 24, wherein separation between said primary and secondary conductors is between about 0.02 mm and 0.075 mm.

28. A coreless transformer as claimed in claim 24, wherein the separation between each layers is between about 0.02 mm and 0.2 mm.

29. A coreless transformer as claimed in claim 24, wherein there are at least ten layers.

30. An electrical circuit comprising a coreless transformer having a primary circuit and a secondary circuit having a number of turns such that said transformer comprises a plurality of layers, each layer having alternating primary and secondary conductors adjacent one another, there being a combination of said number of turns and a number layers sufficient to obtain a transformer action for passing said waveform from said primary circuit to said secondary circuit.

31. A DSL modem comprising an electrical circuit as claimed in claim 30.

32. A digital subscriber line (DSL) modem comprising a line interface transformer having a primary circuit for coupling to a transmission line and a secondary circuit for outputting a signal transmitted over said transmission line, each circuit being formed of a continuous electrically conductive material and in which the primary circuit and the secondary circuit are substantially parallel and are in substantially the same plane.

33. A DSL modem as claimed in claim 32, wherein said primary circuit and said secondary circuit are in the form substantially parallel spirals of the conductive material in substantially the same plane.

34. A DSL modem as claimed in claim 33, wherein the spiral is substantially circular, elliptical, square, rectangular, oval or non-regular.

35. A DSL modem as claimed in claims 33, in which the spiral conforms substantially to a spiral formed by the polar equation r(θ)=αθ, where θ is the angle in polar coordinates, r is the radius and α is a constant that regulates the number of turns and the spacing.

36. A DSL modem as claimed in claim 32, wherein a number of turns of each circuit is at least 10.

37. A DSL modem as claimed in claim 32, wherein there is plurality of planes, each plane forming a layer and in which said primary circuit of each layer is connected together and said secondary circuit of each layer is connected together.

38. A DSL modem as claimed in claim 37, wherein said layers are substantially parallel.

39. A DSL modem as claimed in claim 38, wherein the separation between said layers is not more than 0.5 mm.

40. A DSL modem as claimed in claim 37, wherein the primary circuits are connected in parallel or in series with one another, and the secondary circuits are connected in parallel or series with one another.

41. A DSL modem as claimed in claim 37, wherein there are at least 10 layers.

42. A DSL modem as claimed in claim 37, having an aspect ratio defined as diameter to width of 1:5 or more.

43. A DSL modem as claimed in claim 32, wherein said line interface transformer does not comprise ferromagnetic core.

44. For use in a DSL modem, a line interface transformer having a primary circuit for coupling to a transmission line and a secondary circuit for outputting a signal transmitted over said transmission line, each circuit being formed of a continuous electrically conductive material and in which the primary circuit and the secondary circuit are substantially parallel and are in substantially the same plane.

45. A method of transmitting electronic data over a transmission line, which method comprises the steps of placing said electronic data on said transmission line using a line interface transformer as claimed in claim 44.

46. A method of manufacturing DSL modem, which method comprises the step of a inserting a line interface transformer according to claim 24 and electrically connecting said transformer thereto.
